(19) United States
(12) Patent Application Publication
(10) Pub. No.: US 2014/0374365 A1
(43) Pub. Date: Dec. 25, 2014

(54) Process for Recovering Valuable or Harmful Water-Miscible Liquids From Slurries and an Apparatus Therefor

(71) Applicant: Craig Nazzer, Oakura (NZ)

(72) Inventor: Craig Nazzer, Oakura (NZ)

(21) Appl. No.: 13/823,213

(22) PCT Filed: Feb. 25, 2013
(86) PCT No.: PCT/NZ13/00019

§ 371 Date: Mar. 14, 2013

Related U.S. Application Data
(60) Provisional application No. 61/602,550, filed on Feb. 23, 2012.

(51) Int. Cl. B01D 29/05; B01D 35/22

(52) U.S. Cl. CPC B01D 29/05; B01D 35/22
USPC 210/808; 210/435; 210/413

(57) ABSTRACT

This invention relates generally to a process and an apparatus therefor for recovering valuable or harmful water miscible liquids from mixtures such as slurries that contain such liquids and solid particles.

### FIELD OF THE INVENTION

This invention relates generally to a process and an apparatus therefor for recovering valuable or harmful water miscible liquids from mixtures such as slurries that contain such liquids and solid particles.

### BACKGROUND

Many industrial and commercial processes utilise a valuable and/or potentially harmful liquid that is partially or wholly miscible with water and that becomes mixed with finely divided waste solid matter. For commercial and environmental reasons it is desirable to recover this liquid before disposing of the waste matter. Many types of devices including gravity separators, cyclone separators, filters, clarifiers, centrifuges, and combinations thereof, are used for this purpose.

The simpler gravity and cyclone separators typically yield a waste sludge or sediment that contains a large fraction of the original liquid. Gravity devices can also be unacceptable if the solids particles remain suspended without settling for too long. Filters recover a higher fraction of the original liquid and typically produce a compressed filter cake. Centrifuges, when applied to slurries containing suitable solid matter, can typically extract over 90% of the liquid from the waste, however, centrifuges are complex and relatively costly. It is often more justifiable to use simple devices to recover the bulk of the original liquid, and to then use a smaller sized higher performance unit, such as a centrifuge, for final recovery.

A common drawback of most of these types of solid-liquid separators is that the residual liquid contained in the output waste matter has essentially the same composition as the original valuable or harmful liquid that entered the separator. A similar problem exists with devices that add water to, for example, clean a filter cloth, wash a filter cake, sluice out the solid matter, clean critical surfaces before moving to the next step in the separation process, and so on. The residual valuable or harmful water miscible liquid is then highly diluted by the added water which can make it unviable to recover the residual valuable or harmful liquid; hence it is typically disposed of, possibly with a need for added processing to destroy environmentally harmful components.

The presence of valuable, noxious or toxic process liquids in the waste material can give rise to problems including
purchase of liquid to replace what has been lost with the waste;
release of potentially harmful substances into the environment, or an added cost to destroy harmful components in the waste before disposal;
exposure of operating personnel to potentially hazardous substances; and
consumption of finite natural resources, energy and release of greenhouse gases to manufacture liquid to replace what has been lost with the waste.

An example of an industrial application where these problems arise is in the removal of calcium from glycol based hydrate inhibition systems that are widely used to prevent hydrate formation in oil and gas production facilities. The calcium typically originates as soluble calcium chloride that occurs naturally below ground in formation water or has been added to a well or pipeline by the operator, e.g. in drilling fluids. Pure glycol is a valuable wholly water miscible process liquid that is denser than water and potentially harmful to the environment. Hydrate inhibition systems use aqueous glycol solutions that are valuable, water miscible process liquids that are denser than water and potentially harmful to the environment. Competent oil and gas operators of hydrate inhibition systems strive to recover and repeatedly reuse as much glycol solution as possible in a closed loop system. The calcium, if allowed to accumulate in the glycol solution, can cause severe operational problems.

When faced with this calcium problem large oil and gas operators (e.g. Shell) typically inject soda ash solution that causes the calcium to precipitate as fine particles of insoluble calcium carbonate, which need to then be disposed of as waste. Shell, Chevron, BP, Exxon, Statoil, Petrobras, Anadarko and many other oil and gas producers recognise that it is good environmental and commercial practice to avoid large losses of glycol in the waste material. Several different methods are currently used to recover the glycol process liquid from waste calcium carbonate slurries, including sedimentation, clarification, filtration and centrifugation. These methods vary in complexity, performance, cost and reliability.

For the above calcium carbonate application and in many other situations with other types of solid matter in a wide range of industries, filtration is often selected as offering a good combination of performance, equipment size, and competitive supply. However the problem noted above, namely the loss of significant amounts of residual valuable or harmful process liquid still applies.

This invention represents advancement in regard to solid-liquid filtration processes that are widely used around the world.

It is an object of the present invention to overcome or substantially reduce in severity the above-mentioned difficulties or to at least provide the public with a useful alternative. More particularly, the present invention provides a process to recover water miscible liquids that are denser than water from slurries that contain such liquids and solid particles and an apparatus therefor, or to at least provide the public with a useful alternative.

It is an object of the present invention, which this invention achieves, to substantially improve the solid-liquid filtration processes and apparatuses used when the stream to be treated comprises solid particles and a liquid, hereinafter termed “process liquid”, that is miscible with and denser than water.

### SUMMARY OF THE INVENTION

In a first aspect there is provided a process suitable for recovering one or more water miscible process liquids that are denser than water from a feed slurry that comprises the one or more process liquids and solid particles, the method including the steps of:
(a) installing a substantially horizontal filter medium in a reservoir suitable for holding the one or more process liquids, water, and feed slurry, wherein the filter medium is adapted and dimensioned to allow liquids to flow through it in use, but wherein the filter medium is further adapted to block the passage of substantially all of the solid particles in said feed slurry through the filter medium;
(b) introducing water and the feed slurry separately into said reservoir above the filter medium in such a manner so as to create a distinctive layer of process liquid between the less dense water layer above and the filter medium below, thereby creating a horizontal interface region between the water layer and the process liquid layer, and;
(c) allowing the liquid filtrate that passes through the filter medium to flow out of the reservoir through a filtrate outlet, and;
(d) pressurising the liquid layers above the filter medium to a pressure (P1) that is higher than the pressure (P2) acting beneath the filter medium, the difference in the magnitude of pressures P1 and P2 being sufficient to cause liquid to flow downwards through the filter medium, thereby drawing the interface region between the water and process liquid towards the filter medium, while substantially all the solid particles are blocked from passing through the filter medium, and;
(e) applying one or more suspension means to the process liquid layer to delay or prevent the settling out of a substantial portion of the solid particles onto the surface of the filter medium.

In one embodiment, the process further includes the step of agitating at least a portion of the liquid in the reservoir that is in close proximity to and above the filter medium.

In one embodiment the agitation step is achieved by using moving stirring blades through at least a portion of the process liquid layer, mechanical vibrations, ultrasonic vibrations, or the like.

In one embodiment the process further includes the step of adding a portion of the water layer to the reservoir after the addition of the feed slurry by a method that does not cause excessive mixing of water and process liquid in the interface region between the water and the process liquid.

In one embodiment the agitation step is undertaken in a manner to prevent the formation of a filter cake on the filter medium that would, in the absence of agitation, cause a significant reduction in flow rate through the filter medium but wherein the agitation is effected without causing substantial mixing of water and process liquid in the interface region between the water layer and process liquid layer.

In another embodiment, the process further includes the step of removing some or all of the slurry from the upper side of the filter medium.

In another embodiment the process further includes the additional step of introducing water to flush remaining solid matter out of the reservoir after a substantial portion of the process liquid has passed through the filter medium and flowed out of the reservoir through the filtrate outlet.

In another embodiment the process further includes the optional step of adding further water into the water layer above the filter medium by a method that does not cause excessive mixing of water and process liquid in the interface region between the water and the process liquid.

In one embodiment the one or more process liquids includes one or more glycols, one or more water soluble polymers, one or more amines, and/or a mixture of a glycol with water, a mixture of water soluble polymer with water, a mixture of an amine with water, and/or any mixture thereof.

In one embodiment the process further includes the optional step of applying ultrasonic vibrations to the slurry wherein in use the ultrasonic vibrations aid the separation of the one or more process liquids from the surfaces of the solid particles.

In one embodiment the pressure differential between P1 and P2 is between about 50 kPa and 600 kPa.

In one embodiment at least about 99% of the process liquid in the feed slurry passes through the filter medium and is recovered in the filtrate.

In another aspect, the present invention encompasses an apparatus for performing the process defined above, the apparatus including
(a) a reservoir that in use would receive water and a feed slurry that contains solid particles and one or more water miscible process liquids that are more dense than water;
(b) a filter medium being adapted and dimensioned to allow the passage of liquid and to block the passage of the solid particles in the feed slurry;
   wherein in use, the feed slurry enters the reservoir proximate the filter medium and wherein the solid particles that have been cleaned of the one or more process liquids also exits the reservoir remote from the feed slurry entry and proximate the filter medium; and wherein the reservoir is further adapted and dimensioned to provide a pressure differential across the filter medium.

In one embodiment the apparatus further includes an agitation means to agitate the one or more process liquids above the filter medium.

In one embodiment the filter medium is substantially horizontal across the reservoir.

In one embodiment the reservoir is adapted and dimensioned to provide a pressure differential across the filter member of from about 50 kPa and 600 kPa.

These and other aspects of the present invention will become apparent from the following description, which is given by way of example only, with reference to the accompanying drawing.

### BRIEF DESCRIPTION OF THE DRAWING

FIG. 1 illustrates an apparatus for undertaking a process defined above for separating and recovering process liquid that is denser than and miscible with water from a feed slurry that comprises a mixture of solid particles and such process liquid.

### DETAILED DESCRIPTION OF THE INVENTION

The following is a description of the present invention, including preferred embodiments therefor, given in general terms. The invention is further elucidated from the disclosure which supports the invention and specific illustrations thereof.

The term “about” as used herein in connection with a referenced numeric indication means the referenced numeric indication plus or minus up to 10% of that referenced numeric indication. For example, the language “about 50” units covers the range of 45 units to 55 units.

According to this invention the process liquid and particulate solid matter are thoroughly mixed together to create what is termed the feed slurry. The concentration of solids in the feed slurry is between about 0.1 and 20 vol %. Furthermore, this feed slurry and the one or more process liquids within it are denser than water.

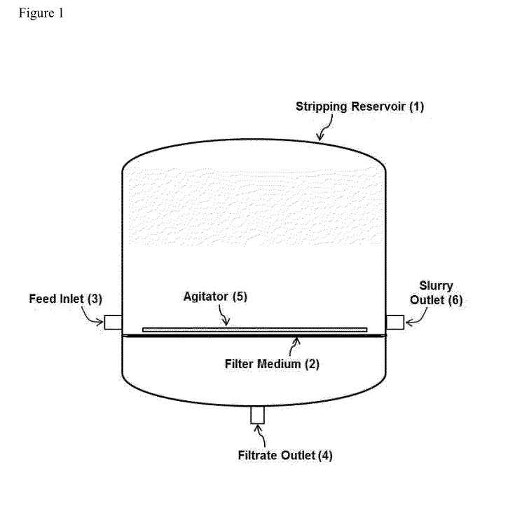

As shown in FIG. 1, the invention provides an apparatus and process for efficiently recovering the one or more process liquids from said feed slurry using low cost equipment and thereby enabling the solids to be removed and disposed of as a clean waste slurry that contains significantly less process liquid than conventionally designed solid-liquid filtration equipment currently in use in many industries.

With reference to FIG. 1, a batch of feed slurry enters the Stripping Reservoir (1), which is partially filled with water, through the Feed Inlet (3) located a short distance above the Filter Medium (2) that is positioned horizontally near the bottom of the Stripping Reservoir (1). The Filter Medium (2) allows liquid to flow through it but blocks the passage of most or all of the solid particles. However at this stage of the process the Filtrate Outlet (4) at the bottom of the Stripping Reservoir (1) is closed hence there is no flow through the Filter Medium (2).

It has been observed by the inventor upon experimentation with mono-ethylene glycol (“MEG”), water and calcium carbonate that, upon entering the Stripping Reservoir (1), the feed slurry slides through the water with negligible mixing and forms a horizontal layer above the Filter Medium (2). The feed slurry is free flowing and denser than the water above it, hence it spreads out evenly over the entire length and breadth of the Stripping Reservoir (1). The water, being less dense than the feed slurry, is pushed upwards by the feed slurry to form the water layer. The feed slurry forms a distinct layer between the Filter Medium (2) and the water layer. A well-defined thin horizontal interface region forms between the water and the liquid in the feed slurry. The liquid above the interface region is essentially all water, while the liquid below the interface region is essentially the same composition as the liquid in the feed slurry. As more slurry enters the Stripping Reservoir (1) the interface region rises. When the interface region is approximately 50 mm or more above the Feed Inlet (3) the feed rate can be significantly increased without risk of causing noticeable mixing between the water and the process liquid.

Despite the fact that MEG is totally miscible with water and the feed slurry flows through some of the water to reach the Filter Medium (2), the above described interface region has been observed to be surprisingly sharp, stable and persistent even if the feed slurry is initially injected at a velocity of up to 20 cm/sec. Furthermore the interface region does not breakdown over time. There is no readily discernible increase in process liquid concentration in the water if the feed slurry and water are left standing as is for long periods of time (e.g. overnight) in the Stripping Reservoir (1).

Alternatively the feed slurry can enter the Stripping Reservoir (1) before the water is put in. The water is then gently sprayed into the top of the Stripping Reservoir (1) after at least some of the feed slurry has entered the Stripping Reservoir (1). The small water droplets gently accumulate on top of the denser liquid in the feed slurry with minimal mixing. This is an optional method of creating the distinct interface region between the water and the liquid in the feed slurry. In a variation of this option, water can also be added through a hose and floating distributor.

The space at the top of the Stripping Reservoir (1) is pressurised, e.g. with air or nitrogen. The Filtrate Outlet (4) is then opened. As soon as the liquid level below the Filter Medium (2) drops, a differential pressure is created across the Filter Medium (2). This pressure difference causes the water in the upper part of the Stripping Reservoir (1) to push down on top of the feed slurry and force liquid through the Filter Medium (2). The pressure difference can also be created or increased by applying a vacuum to the Filtrate Outlet (4). The liquid that flows downward through the Filter Medium (2) is termed the filtrate.

The edges of the Filter Medium (2) form a seal with the internal walls of the Stripping Reservoir (1) such that all liquid moving toward the Filtrate Outlet (4) must pass through the Filter Medium (2).

In commonly available filtration equipment, solid matter typically forms a filter cake on the surface of the filter medium. As the filter cake thickness increases, the resistance to flow increases, thereby reducing the flow of filtrate, assuming no change in the pressure difference across the filter medium. Filtration efficiency drops and a typical response is to install a larger filter with more surface area, add complex filter cleaning systems, and/or add filter aid.

If the decrease in filtrate flow rate is unacceptable then the differential pressure across the filter can be raised as the filter cake becomes thicker so as to maintain high filtrate flow rates. This increases cost and complexity, and for some types of solid matter it also creates a more compacted filter cake that can be more difficult to extract process liquid from, remove from the filter surface, and dispose of.

This invention described herein overcomes the above problems by avoiding the creation of a thick filter cake, thus reducing the requirement for high pressure to maintain high filtrate flow rates. In contrast the present process and apparatus are designed to promote the suspension of the solid particles in the process liquid and to hinder or prevent the settling out onto the Filter Medium (2). One means of doing this is to operate an Agitator (5) located close to the top surface of the Filter Medium (2). The Agitator (5) creates turbulence in the fluid immediately above the Filter Medium (2) and prevents the solid particles from settling and forming a cake, or if a cake does form the Agitator (5) ensures that it remains thin enough to avoid the undesired reduction in filtrate flow rate that occurs with thick cakes. The higher filtrate flow rate results in a shorter processing time for each batch of feed slurry.

A further benefit of the agitation is that most, if not all, the solid particles remain suspended. This exposes the surfaces of the particles to the surrounding liquid thereby helping the descending water to push the process liquid downwards off the surfaces of the solid particles.

In another possible area of application dispersants are used in anti-scaling procedures when troublesome solid matter is removed from pipes and equipment. This suggests that in some situations this invention will be suitable for recovering process liquid from waste slurries produced by such procedures. Operators who use these anti-scaling procedures can be faced with problems in disposing of the waste slurries and sometimes decide to destroy the waste without recovering the process liquid, e.g. using acid, incineration or other form of destructive treatment so as to avoid or simplify final disposal. This invention presents an alternative option that efficiently cleans the waste solids and recovers the process liquid instead.

The encouragement of a suspension of particles by, for example, agitation, is substantially different from the design concepts applied in many conventional filtration systems that rely on the formation of a thick filter cake. Many such filters include a cake washing step using water to wash process liquid out of a compressed filter cake.

In conventional filters that have a cake washing step, process liquid can become trapped and unreachable by the washing water in dense regions of the cake. Cracks can also be present in the cake, through which the wash water may prefer to flow, thereby bypassing large parts of the cake. Thirdly the cake may have uncontrollable variations in thickness and permeability that lead to uneven washing. Fourthly, where filter aid has been used, the increase in solid matter due to the filter aid increases the number of sites where process liquid can be trapped. Finally the wash water may not always be evenly distributed across the filter cake. These problems are typically well known by filtration system designers and operators.

The present invention avoids these problems by holding a large fraction of the particles in suspension, thereby enabling the descending water to surround the particles individually and strip process liquid from the particle surfaces.

The Agitator (5) is designed to avoid creating unacceptably large vertical currents that might otherwise cause excessive mixing of water and process liquid in the interface region between the water layer and the denser process liquid layer in the slurry. As noted above this interface region is stable and persistent, and although it can withstand surprisingly large amounts of turbulence the Agitator (5) is designed and operated to minimise the risk of excessive mixing of water and process liquid.

In one embodiment the Agitator (5) comprises an assembly of horizontal blades that is placed close to the surface of the Filter Medium (2) and connected to a motor that imparts either rotational or linear horizontal movement to the blades such that when the blades are moving they continually lift solid matter from the surface of the Filter Medium (2). The number of and velocity of the blades are selected so that a blade passes over each part of the surface of the Filter Medium (2) at an adjustable frequency between about 0.1 and about 10 times per second, depending upon the settling characteristics and cake forming tendencies of the solid matter. This creates a Turbulent Zone in the liquid immediately above the Filter Medium (2). The blade profile is shaped to promote localised turbulence that holds the particles in suspension. Optionally horizontal baffles are also placed above the blades to block excessive vertical fluid movement and limit the height of the Turbulent Zone.

The Agitator (5) can be operated at variable speeds so that the depth of the Turbulent Zone above the Filter Medium (2) can be varied between typically about 10 and about 1000 mm inside a Stripping Reservoir (1) in which the feed slurry fills the volume above the Filter Medium (2) to a depth of between about 100 to about 2000 mm. At the start of filtration immediately after the batch of feed slurry has entered the Stripping Reservoir (1), the Agitator (5) moves at high speed so as to maximise the filtration rate through the Filter Medium (2). This is possible because the water-process liquid interface region is far above the Filter Medium (2) and a deep Turbulent Zone will not overly disturb this interface. As the interface region descends and comes closer to the Filter Medium (2) the Agitator (5) speed may be reduced as needed to reduce the risk of excessive mixing of water and process liquid.

While the Agitator (5) is moving the less dense water continuously pushes down on top of the feed slurry and pushes more and more liquid out of the feed slurry and through the Filter Medium (2). The liquid that had been in the original feed slurry is pushed through the Filter Medium (2) and recovered in the Filtrate. The water descends in a generally horizontal front through the slurry. The process liquid in the slurry is replaced by water from the top down. As the interface region descends it becomes thicker as progressively more particles are stripped of process liquid and more mixing occurs between the water and process liquid. The mixing is permanent and irreversible because the process liquid is miscible with water.

In one mode of operation the stripping and filtration described above continue until the volume of filtrate exceeds the total volume of water that had been put into the Stripping Reservoir (1). This volume is typically about 1 to about 2.5 times the original volume of the feed slurry, so as to ensure enough water passes through the slurry to push substantially all of the process liquid through the Filter Medium (2). The optimum volume of water to use varies depending upon the details of each application including the properties of the components of the feed slurry and the amount of agitation applied.

This simple mode of operation avoids many of the complex steps that are used in conventional highly mechanised filters.

Alternatively the amount of water required can be reduced by applying less agitation. This reduces the degree of mixing between the water and the process liquid, which in turn means the concentration of process liquid in the filtrate will be higher. However there may also be a greater risk of particles settling, forming a filter cake, and reducing the filtrate flow rate. The operator may choose to accept the resulting increase in processing time or to increase the agitation. to increase the filtrate flow rate.

In another alternative mode of operation, a first phase of the feed slurry filtration may be done with little or no water added to the Stripping Reservoir (1). The top of the slurry layer descends as process liquid passes through the Filter Medium (2), reducing the volume of slurry and increasing its solids content. Vigorous agitation is possible during this phase. When this phase is completed water is then gently sprayed into the upper part of the Stripping Reservoir (1) so that it accumulates as a layer of water sitting on top of the denser process liquid in the slurry, and the Stripping Reservoir (1) resumes operation in the manner described in the above paragraphs.

Filtration, using any of the above described modes of operation, continues until the collected volume and quality of filtrate indicate that the target quantity of process liquid has been recovered. Recovery of over 99.5% of the original process liquid that had been in the feed slurry is typically achievable. As described earlier this performance is achieved with minimal dilution because this invention applies a novel form of displacement with minimal mixing, rather than dilution, plus the retention of a large fraction of the particles in suspension, rather than encouraging cake formation, to achieve its objectives.

After filtration has been completed the Slurry Outlet (6) above the Filter Medium (2) is opened, allowing the now clean slurry to be drained and disposed of. More water is added as needed to wash out the equipment and the Agitator (5) is run at high speed to help mobilise the solid matter. Optionally, back wash water or gas is injected into the Filtrate Outlet (4) to flow upwards and help clean the Filter Medium (2).

After drainage is complete the Stripping Reservoir (1) is ready to repeat the cycle to process the next batch of feed slurry.

### EXAMPLE 1

As noted above oil and gas operators use mono-ethylene glycol (“MEG”) in hydrate inhibitions systems, and on some projects there is a need to recover the MEG from waste slurries that contain fine precipitated calcium carbonate particles. This invention is well suited to this application.

The calcium is first precipitated as calcium carbonate, typically by adding soda ash solution. On some projects this is done on the calcium contaminated dilute MEG that enters the MEG recovery plant, while on others the precipitation is done within a part of the MEG recovery plant where the calcium and MEG are both concentrated. The present invention is well suited to both applications and offers notable advantages over conventional filters now being used for these applications.

The conventional filtration approach comprises installing a filter designed for calcium carbonate removal, for which there are many choices including filter press, pressure filter, continuous belt filter, and candle filter. These filter types all produce a filter cake which, optionally, may be washed in-situ with wash water prior to removal and disposal. For commercial and environmental reasons it is typically good practice to optimise the selection and operation of the calcium carbonate filters to maximise MEG recovery.

For illustration, using design data from a MEG recovery plant at an existing gas production site, the filtration design capacity was 1000 kg/d of calcium carbonate that had been precipitated by mixing soda ash solution containing 600 kg/d of dissolved carbonate ions with the dilute MEG stream entering the facility. The carbonate ions are intended to react with 400 kg/d of dissolved calcium ions contained in dilute MEG stream to produce 1000 kg/d of fine insoluble calcium carbonate particles. This yields 430 m³/d of calcium carbonate-MEG-water slurry having a calcium carbonate concentration of 0.2 wt % as insoluble fine particles.

Some of the conventional filtration systems designed for this application would typically use filter aid to form a pre-coat, followed by body feed during the batch filtration step to improve the rate of filtration. However the use of pre-coat and body feed requires a separate solids handling system and the purchase of additional consumables. In addition the filter aid comprises solid particles that add to the filter solids loading, which increases the volume of waste and can potentially trap process liquid thereby reducing the degree of process liquid recovery.

Alternatively more operational steps and mechanisms can be added to the filtration package, for example, to scrape the filter medium, blow nitrogen through the cake to remove and recover process liquid, and wash the cake with water to remove and recover more process liquid. The above measures add cost and complexity to the filtration system, however they would enable some types of conventional filtration systems to achieve good MEG recovery from the calcium carbonate-MEG-water slurry described above.

Tests using the present invention have been done on calcium carbonate-MEG-water slurries. These tests show that, for the application described above, over 99.9% of the MEG can be recovered. No filter aid is needed. The tests show that the filter cake can be avoided or at least limited to a thickness of less than about 0.5 to 1.0 mm. It was surprisingly observed as well that even after long periods of agitation there was a persistent steep gradient of MEG concentration across the agitated slurry. The thickness of the agitated slurry initially decreases rapidly as liquid is drained through the filter medium but then stabilises when the solids concentration reaches about 5 to 8 vol %. The water descending from above is then able to displace MEG from the slurry from the top down.

In the final filtration phase there is no more liquid above the slurry. The liquid in the slurry, which is by now over 99% water, is pushed out of the slurry, through the filter medium and into the filtrate. The slurry solids concentration rises. Vigorous agitation helps to maximise the filtrate flow rate. The measured MEG concentrations in slurry samples taken at the end of the stripping and filtration step were lower than 4 g per litre. By comparison a conventional filtration system designed for the calcium carbonate-MEG-water slurry application described above, and with a cake washing system included, would likely have a final MEG concentration of more than 60 g per litre. Furthermore the wash water further dilutes the filtrate, resulting in higher costs to remove the excess water by distillation in another part of the MEG recovery plant.

The difference in MEG recovery between conventional filtration and the present invention, when applied to the 1000 kg/d calcium carbonate project example described above, amounts to a saving of about 400 tpy of MEG, which in turn equates to more than $1 million in annual cost reduction for MEG procurement, storage and transport. In addition there will be other cost savings e.g. no filter aid to purchase and handle, and less wash water to distil out of the filtrate. Furthermore the capital cost to purchase and install the present invention is estimated to be less than the capital cost of the high performance conventional filtration systems that have been considered for the above described project.

The calcium can alternatively be removed from concentrated MEG streams drawn from within the MEG recovery plant. This yields a calcium carbonate-MEG-water slurry having typically 2 to 5 wt % solids, but the same total solids, i.e. in this particular case 1,000 kg/d of waste calcium carbonate. The liquid load would be substantially lower. Both the present invention and conventional filtration systems would be feasible. The starting point for the filtration, i.e. 2-5% solids vs 0.2% previously, would only have a limited effect on the composition and MEG content in the final waste product when expressed as g MEG loss per kg calcium carbonate removed. Hence the advantages of the present invention would be similar to those described above for the dilute MEG case.

While the invention has been described herein, with reference to certain preferred embodiments, a person of ordinary skill in the art will recognize that many of the components and parameters may be varied or modified without departing from the scope of the invention.

The entire disclosure of all patent applications, patents, and publications cited herein are hereby incorporated by reference in their entirety.

In addition, it should be noted that titles, headings, and the like are provided to enhance the reader's comprehension of this document, and are not limiting to the scope of the present invention.

Throughout the specification, and any sections that follow, unless the context requires otherwise, the words “comprise”, “comprising”, and the like, are to be construed in an inclusive sense as opposed to an exclusive sense, that is to say, in the sense of “including but not limited to”.

Where in the foregoing description reference has been made to integers having known equivalents thereof, then those equivalents are herein incorporated as if individually set forth.

Although this invention has been described with reference to particular embodiments and examples, it is to be appreciated that improvements or modifications can be made to the present invention without departing from the scope of the claims.

In summary, and when compared to previous devices and methods, the invention described herein applies process steps and equipment details that are distinctive, either individually or when considered in combinations with one another.

1. A process suitable for recovering one or more water miscible process liquids that are denser than water from a feed slurry that comprises the one or more process liquids and solid particles, the process comprising:
(a) introducing water and the feed slurry separately into said a reservoir suitable for holding the one or more process liquids, water and feed slurry, the reservoir further comprising a substantially horizontal filter medium wherein the filter medium is configured and dimensioned to allow liquids to flow through it in use, but wherein the filter medium is further adapted to block the passage of substantially all of the solid particles in said feed slurry through the filter medium, where the water and feed slurry are introduced separately above the filter medium in such a manner so as to create a distinctive layer of process liquid between the less dense water layer above and the filter medium below, thereby creating a horizontal interface region between the water layer and the process liquid layer, and;
(b) allowing the liquid filtrate that passes through the filter medium to flow out of the reservoir through a filtrate outlet, and;
(c) pressurising the liquid layers above the filter medium to a pressure (P1) that is higher than the pressure (P2) acting beneath the filter medium, the difference in the magnitude of pressures P1 and P2 being sufficient to cause liquid to flow downwards through the filter medium, thereby drawing the interface region between the water and process liquid towards the filter medium, while substantially all the solid particles are blocked from passing through the filter medium, and;
(d) applying one or more suspension means to the process liquid layer to delay or prevent the settling out of a substantial portion of the solid particles onto the surface of the filter medium.

2. The process as claimed in claim 1, wherein the process of applying the suspension means includes agitating at least a portion of the process liquid in the reservoir that is in close proximity to and above the filter medium.

3. The process as claimed in claim 2, wherein the agitating is undertaken in a manner to prevent the formation of a filter cake on the filter medium that would, in the absence of agitation, cause a significant reduction in flow rate through the filter medium but wherein the agitating is effected without causing substantial mixing of water and process liquid in the interface region between the water layer and process liquid layer.

4. The process as claimed in claim 2, wherein the agitating is achieved by using a method selected from the group consisting of (i) moving stirring blades through at least a portion of the process liquid layer, (ii) mechanical vibrations or (iii) ultrasonic vibrations and combinations thereof.

5. The process as claimed in claim 1, wherein the process further comprises adding a portion of the water layer to the reservoir after introducing the feed slurry, where the adding is by a method that does not cause excessive mixing of water and process liquid in the interface region between the water and process liquid.

6. The process as claimed in claim 1, wherein the process further comprises removing some or all of the slurry from the upper side of the filter medium.

7. The process as claimed in claim 1, wherein the process further comprises introducing water to flush remaining solid matter out of the reservoir after a substantial portion of the process liquid has passed through the filter medium and flowed out of the reservoir through the filtrate outlet.

8. The process as claimed in claim 1, wherein the process further comprises adding further water into the water layer above the filter medium by a method that does not cause excessive mixing of water and process liquid in the interface region between the water and the process liquid.

9. The process as claimed in claim 1, wherein the one or more process liquids is selected from the group consisting of one or more glycols, one or more water soluble polymers, one or more amines, a mixture of a glycol with water, a mixture of water soluble polymer with water, a mixture of amine with water and/or mixture thereof and combinations thereof.

10. The process as claimed in claim 1, wherein the process further comprises applying ultrasonic vibrations to the slurry wherein in use the ultrasonic vibrations aid the separation of the one or more process liquids from the surfaces of the solid particles.

11. The process as claimed in claim 1, wherein a pressure differential applied between P1 and P2 is between about 50 kPa and 600 kPa.

12. The process as claimed in claim 1, wherein at least about 99% of the process liquid in the feed slurry passes through the filter medium and is recovered in the filtrate.

13. An apparatus for recovering one or more water miscible process liquids that are denser than water from a feed slurry that comprises one or more process liquids and solid particles, the apparatus comprising:
(a) a reservoir configured to receive water and a feed slurry that contains solid particles and one or more water miscible process liquids that are more dense than water;
(b) a filter medium installed within the reservoir and configured and dimensioned to allow the passage of liquid and to block the passage of the solid particles in the feed slurry;
wherein in use, the feed slurry enters the reservoir proximate the filter medium and wherein the solid particles that have been cleaned of the one or more process liquids also exits the reservoir remote from a feed inlet and proximate the filter medium; and wherein the reservoir is further configured and dimensioned to provide a pressure differential across the filter medium.

14. The apparatus as claimed in claim 13 further including an agitation means above the filter medium to agitate the one or more process liquids above the filter medium.

15. The apparatus as claimed in claim 13 wherein the filter medium is substantially horizontal across the reservoir.

16. The apparatus as claimed in claim 13, wherein the reservoir is configured and dimensioned to provide a pressure differential across the filter medium of from about 50 kPa and 600 kPa.

17. An apparatus for recovering one or more water miscible process liquids that are denser than water from a feed slurry that comprises one or more process liquids and solid particles, the apparatus comprising:
(a) a reservoir configured to receive water and a feed slurry that contains solid particles and one or more water miscible process liquids that are more dense than water;
(b) a substantially horizontal filter medium installed within the reservoir and configured and dimensioned to allow the passage of liquid and to block the passage of the solid particles in the feed slurry;
(c) a feed inlet above and proximate to the filter medium;
(d) a slurry outlet above, proximate to the filter medium and remote from the feed inlet; and
(e) a filtrate outlet below the substantially horizontal filter medium wherein in use, the feed slurry enters the reservoir proximate the filter medium through the feed inlet, and wherein the solid particles that have been cleaned of the one or more process liquids also exits the reservoir remote from the feed inlet and proximate the filter medium; and wherein the reservoir is further configured and dimensioned to provide a pressure differential across the filter medium.

18. The apparatus as claimed in claim 17 further including an agitation means above the filter medium to agitate the one or more process liquids above the filter medium.

19. The apparatus as claimed in claim 17, wherein the reservoir is configured and dimensioned to provide a pressure differential across the filter medium of from about 50 kPa and 600 kPa.
